(19) United States
(12) Patent Application Publication
(10) Pub. No.: US 2013/0051908 A1
(43) Pub. Date: Feb. 28, 2013

(54) APPARATUS AND METHOD FOR CONTROLLED ACCESS

(71) Applicant: Bruno Jean FRANCOIS, Atlanta, GA (US)

(72) Inventor: Bruno Jean FRANCOIS, Atlanta, GA (US)

(21) Appl. No.: 13/597,723

(22) Filed: Aug. 29, 2012

Related U.S. Application Data
(60) Provisional application No. 61/528,985, filed on Aug. 30, 2011.

(51) Int. Cl. F16B 21/06

(52) U.S. Cl. 403/327

(57) ABSTRACT

An access control apparatus and method include a first part having a follower extending therefrom, and a second part defining an allow-access follower path and a prevent-access follower path. Normal actuation of equipment associated with the access control apparatus causes the follower to traverse the prevent-access follower path and limit access or use of the associated equipment. Actuation of the equipment in a prescribed non-intuitive manner allows the follower to traverse the allow-access follower path and permits access or use of the associated equipment.

### CROSS-REFERENCE TO RELATED APPLICATIONS

This application claims the benefit of U.S. Provisional Patent Application Ser. No. 61/528,985 filed Aug. 30, 2011, the entirety of which is hereby incorporated herein by reference for all purposes.

### TECHNICAL FIELD

The present invention relates generally to the field of devices and methods for controlling access to or use of various spaces or equipment, and more particularly to a keyless manually-actuated locking mechanism for preventing unauthorized use or access by children or others lacking knowledge of the mechanism's manner of operation.

### BACKGROUND

Child-proof locking mechanisms are used to prevent children from accessing cabinets, drawers, rooms and other spaces or containers, as well as for preventing operation of equipment such as hot water faucets, toilet lids, safes, doors, gates and the like. Various forms of access control apparatus and methods are also used for preventing unauthorized access by adults and/or children to spaces and equipment, such as for example combination locks, latches, etc.

Typically, known access control equipment involves time-consuming and often complex installation of equipment and/or modification of existing cabinets, drawers and other structures. Also, operation of many known access control systems and method is not intuitive, rendering it difficult for even authorized users to operate. Known access control equipment also commonly must be removed entirely if general access is to be allowed, not allowing for selective actuation and overriding of the access control features.

Accordingly, it can be seen that needs exist for continued improvement to methods and apparatus for access control. It is to the provision of improved methods and apparatus for access control meeting these and other needs that the present invention is primarily directed.

### SUMMARY

In example embodiments, the present invention provides improved methods and apparatus for access control, such as for example mechanisms for preventing children or other unauthorized users from accessing a space or using equipment. The apparatus and method of example embodiments includes a serpentine pathway and a follower, wherein the serpentine pathway prevents access or use if a defined sequence of operation is not followed. The apparatus and method of example embodiments is readily adaptable to use in connection with drawers, doors, cabinets, cabinet hinges, gates, locks, safes, toilet seats, faucets and other equipment. The apparatus and method of example embodiments allows easy retrofit of existing equipment, and/or incorporation as original equipment in various products. The apparatus and method of example embodiments also permits selective actuation and overriding of the access control features when not needed, for example by actuation of an on/off button to activate or deactivate the locking mechanism, without removal or damage to the equipment.

Example embodiments of the invention allow for one hand operation, for example allowing a user to access or use associated equipment with light manual actuation force (one or two fingers) applied on the handle or other standard actuator of the associated equipment. No buttons or parts have to be located and pushed, held or bent to operate the access control apparatus of example embodiments of the invention, and no release tool or key is needed. The unlocking process may be completely carried out by operation of the associated equipment in its normal manner of use, for example in a specified sequence of back-and-forth motion of the associated equipment, without the user contacting the access control apparatus. In this manner, operation in total darkness is advantageously enabled. In example embodiments, only a single point of contact between the user and the associated equipment allows actuation of the access control apparatus.

In one aspect, the present invention relates to an access control apparatus for controlling access to associated equipment. The access control apparatus preferably includes a follower path with at least one allow-access pathway portion and at least one prevent-access pathway portion. The access control apparatus preferably also includes a follower movable along the follower path. The access control apparatus preferably also includes biasing means for biasing the follower toward the prevent-access pathway portion upon a standard actuation of the associated equipment, and for allowing the follower to follow the allow-access pathway portion upon a non-standard actuation of the associated equipment. The prevent-access pathway portion preferably limits operation of the associated equipment and the allow-access pathway portion allows operation of the associated equipment.

In another aspect, the invention relates to a method of controlling access to associated equipment. The method preferably includes providing an access control apparatus comprising a follower path having at least one allow-access pathway portion and at least one prevent-access pathway portion, and a follower movable along the follower path. The method preferably also includes biasing the follower toward the prevent-access pathway portion upon a standard actuation of the associated equipment. The method preferably also includes selectively actuating the associated equipment to cause the follower to follow one of the allow-access pathway portion and the prevent-access pathway portion. Following the prevent-access pathway portion preferably limits operation of the associated equipment and following the allow-access pathway portion preferably allows operation of the associated equipment.

In still another aspect, the invention relates to an access control apparatus including a first part having a follower arm extending therefrom, the follower arm being biased toward a starting position and having a follower extending from the follower arm. The apparatus preferably also includes a second part having a first limit member, a second limit member, and a gate, the gate being movable between a closed position bridging the first and second limit members, and an open position allowing passage of the follower between the first and second limit members. The gate is preferably biased toward the closed position. The first and second limit members and the gate preferably define an allow-access pathway and a prevent-access pathway. Movement of the follower along the allow-access pathway preferably allows opening of the access control apparatus and movement of the follower along the prevent-access pathway preferably prevents opening of the access control apparatus.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a first perspective view of an access control apparatus according to an example embodiment of the present invention.

FIG. 2 is another perspective view of the access control apparatus of FIG. 1.

FIGS. 3-14 show various steps of a sequence of operation of the access control apparatus of FIG. 1.

FIG. 15 shows an “allow-access” pathway of actuation for the access control apparatus of FIG. 1.

FIG. 16 shows a first “prevent-access” pathway of actuation for the access control apparatus of FIG. 1.

FIG. 17 shows a second “prevent-access” pathway of actuation for the access control apparatus of FIG. 1.

FIG. 18 shows a perspective assembly view of an access control apparatus according to another example embodiment of the present invention.

FIG. 19 shows a perspective assembly view of a plurality of rings of the access control apparatus shown in FIG. 18.

FIG. 20 shows a front cross-sectional view of the plurality of rings of FIG. 19 assembled and configured for providing access control.

FIG. 21 shows both “prevent access” and “allow access” pathways of actuation for the access control apparatus of FIG. 18.

FIG. 22 shows a partial cross-sectional view of a portion of the plurality of assembled rings of FIG. 18, and further shows the lateral positions of an inner ring for providing engagement therewith.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

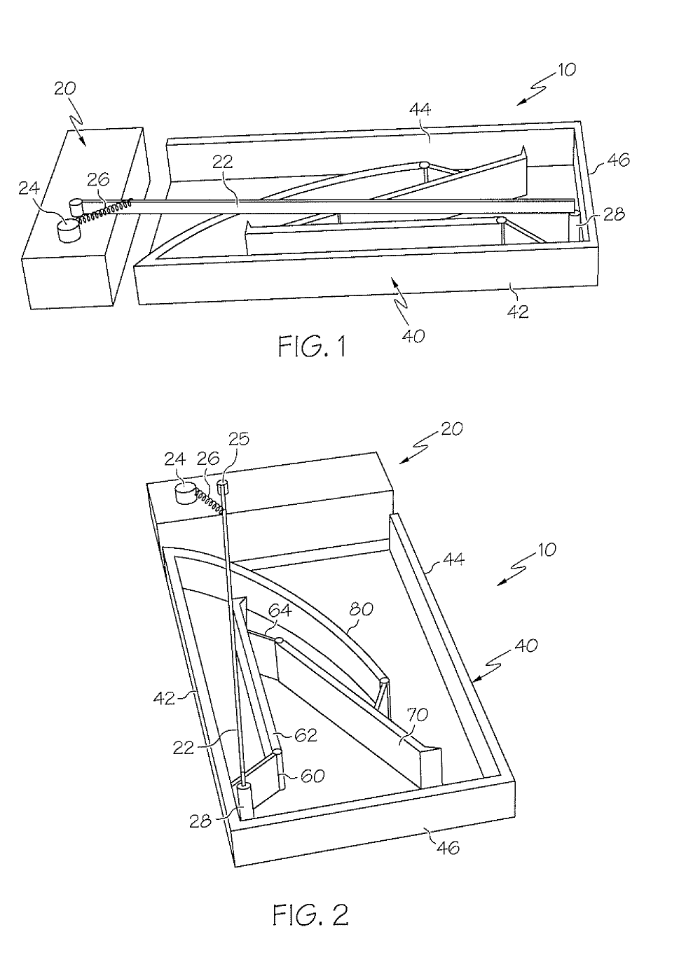

With reference now to the drawing figures, wherein like reference numbers represent corresponding parts throughout the several views, FIGS. 1 and 2 show an access control apparatus 10 according to one example embodiment of the invention. The depicted embodiment is translationally actuated, with its access control mechanism operating in a back-and-forth motion, but in alternate forms of the invention a rotational clockwise-counterclockwise motion actuates the access control mechanism. Example forms of the apparatus and method of the invention may be adapted to use in connection with drawers, doors, cabinets, hinges, gates, locks, safes, toilet seats, faucets and other equipment having hinges, sliding rails or other moving parts. In alternate forms, the apparatus and method of the invention may be adapted to use as a combination lock, a puzzle or game for amusement, and/or for other purposes.

The access control apparatus 10 of the depicted example generally comprises a first part 20 and a second part 40, the first and second parts being translationally movable relative to one another. In the depicted embodiment, the first part 20 is a moving part and the second part 40 is a stationary part, but in alternate embodiments either or both parts may be the moving part. A follower arm 22 has a first end connected to the first part 20 by a pivotal connection 25, and a second free end. An intermediate portion of the follower arm 22 between the first and second ends is connected to the first part 20 at a hub 24 or other connector by means of a spring 26 or other biasing element. In alternate embodiments the follower arm may be a flexible rod fixedly attached to the first part 20 or integrally formed therewith, and may be formed of a resilient material to flex along its length rather than being pivotally mounted. A follower 28 projects generally transversely, for example at a right angle, from the second end of the follower arm 22.

The second part 40 generally comprises a frame formed by first and second side walls 42, 44 a rear end wall 46 and a front end wall 80. In the depicted embodiment, the walls 42, 44 and 46 define a generally rectangular frame with an open proximal end adjacent the curved or arcuate front end wall 80, but in alternate embodiments one or more sidewalls can define an exterior periphery of differing configurations, or one or more portions of the frame can be omitted, or the frame can be omitted altogether in favor of one or more interior limit members. The second part 40 further comprises one or more internal limit members and/or one-way gates defining one or more serpentine follower path(s), as will be described in example form below. The follower path(s) preferably comprise at least one “allow-access” pathway portion, and at least one “prevent-access” pathway portion, with a bias or default toward the “prevent-access” pathway portion if a user does not follow a prescribed actuation sequence. It will be understood that the drawings are not necessarily to scale, and that the spacing between walls is larger than would typically be necessary in actual applications, for better clarity in understanding the operation of the apparatus. In various practical applications, smaller, larger or otherwise configured equipment is within the scope of the invention.

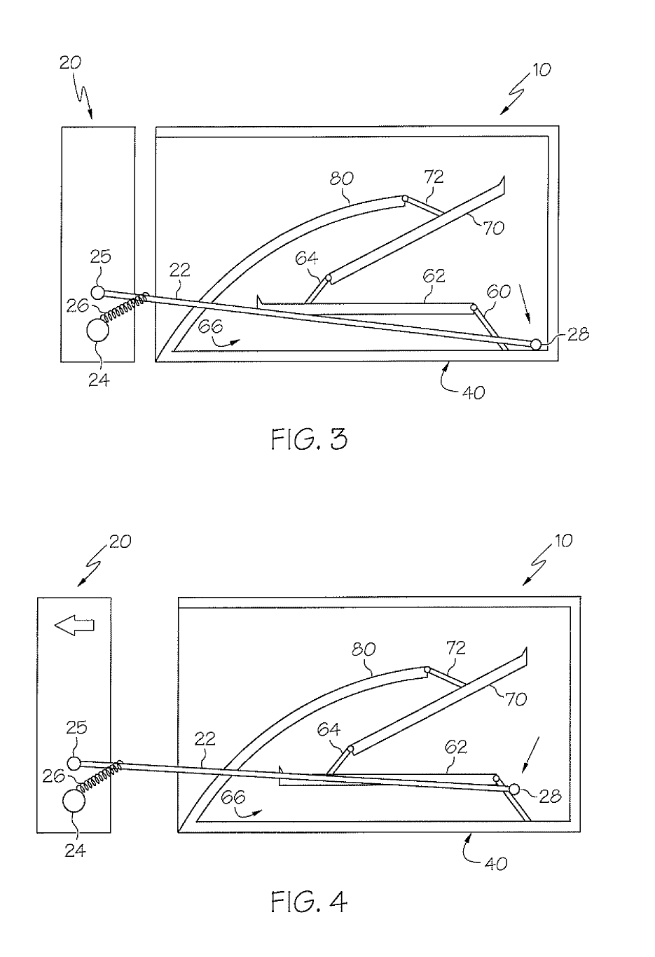

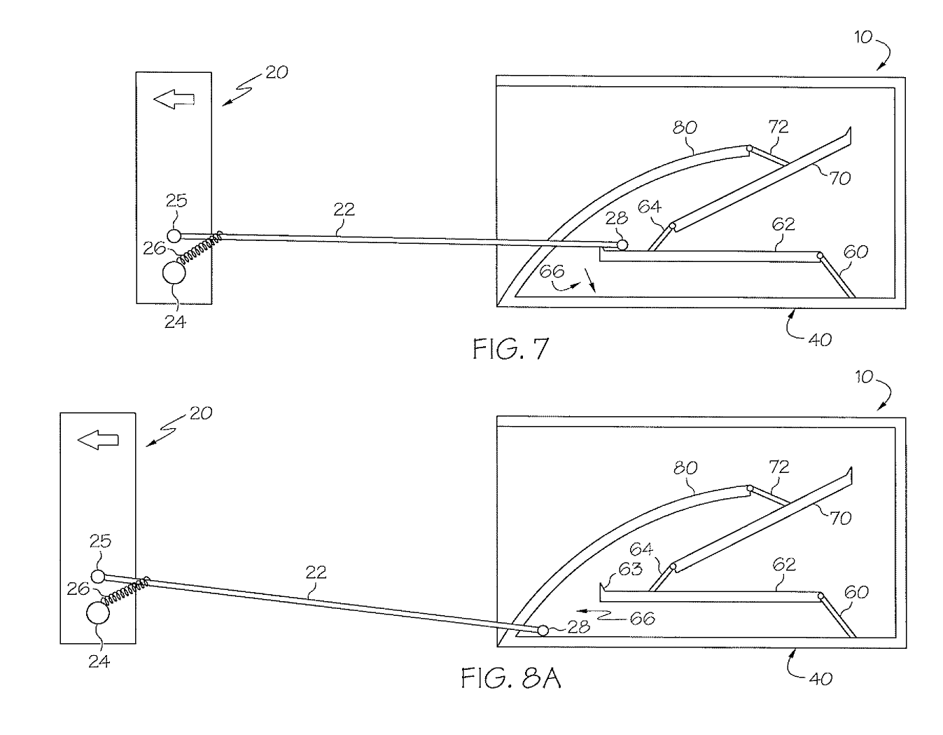

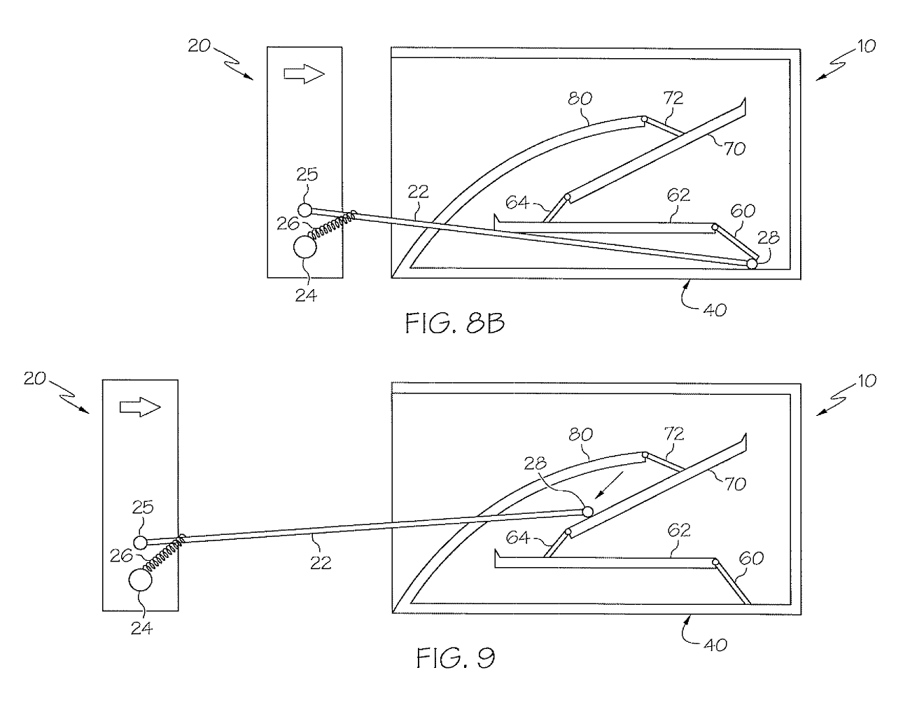

FIGS. 3-14 show example steps along a sequence of actuation of the access control method and apparatus 10, according to example forms of the invention. The biasing member 26 is in tension and biases the follower arm 22 in a generally downward direction relative to the figures. FIG. 3 shows the apparatus 10 in a starting or neutral (closed) position. In example forms, the first part 20 is affixed to or integral with a moving component of the container, structure or other associated equipment to which access is to be controlled, and the second part 40 is affixed to or integral with a fixed or stationary component thereof. For example, the first part 20 may be affixed to a drawer or cabinet door, and the second part 40 affixed to the cabinet base or frame in/to which the drawer or cabinet door is mounted. Alternatively, the first part 20 may be affixed to an access door, and the second part 40 affixed to the door frame. In the starting or neutral position shown in FIG. 3, the drawer or door is in a closed position, preventing access to the contents or area or preventing further operation of the equipment to which access is to be controlled.

As the drawer or door is moved toward an open position (to the left, as indicated in FIG. 4), the attached follower arm 22 and follower 28 likewise move in connection therewith. The follower 28 moves along an inclined face of a first one-way gate 60. The angle of inclination of the face of the gate 60, the tension and/or stiffness of the biasing spring 26, and/or the materials of the gate and/or the follower 28 are selected to allow the follower to slide smoothly along the face of the gate upon application of a light to moderate manual actuation force applied to the drawer or door by a user, allowing the follower arm 22 to pivot or flex in the direction opposite the bias of the spring (upward in the figures). The one-way gates described herein may be spring-biased, weighted for gravity bias in a downward direction, magnetically biased, formed of a resilient material, or otherwise biased to allow passage of the follower through the gate in a first direction, but prevent passage through the gate in an opposite second direction.

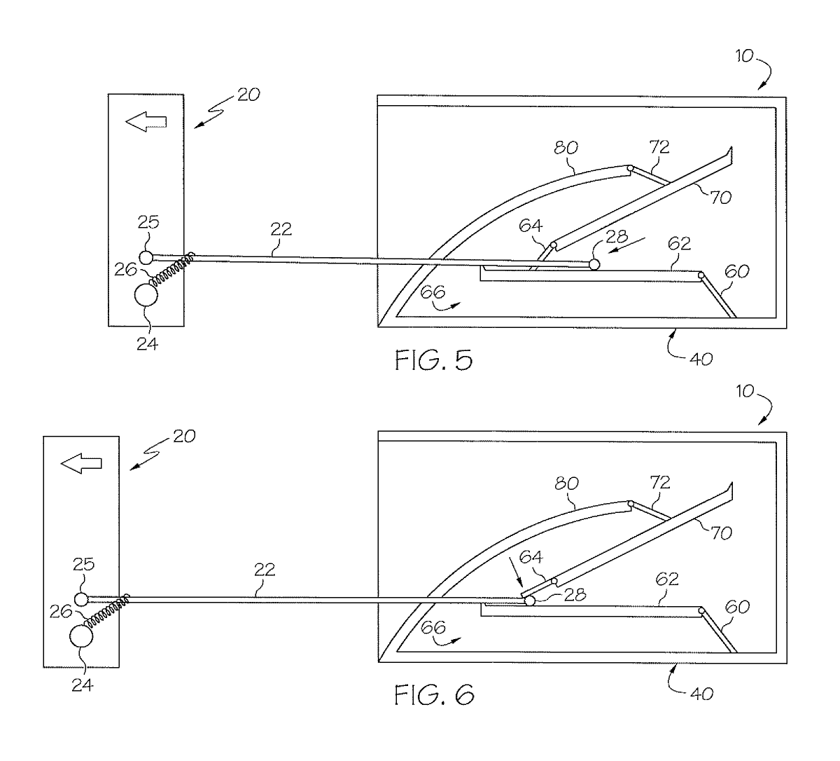

As the drawer or door is moved further toward its open position, as shown in FIGS. 5-7, the follower 28 moves along or adjacent a first interior limit member 62, and through a second one-way gate 64 that is pivotally coupled to the end of the first interior limit member. As the follower 28 passes through the second one-way gate 64, the gate provides audible, tactile or other feedback indication to the user, for example making a clicking sound and/or vibration, which indicates to the user that a directional change or other actuation operation is required to continue following the “allow-access” portion of the actuation pathway. If the user continues pulling the drawer or door toward its open position (to the left in the figures), the follower passes beyond an end of the first interior limit member 62, and drops under the bias of spring 26 into a “prevent-access” portion of the pathway, as shown in FIG. 8A. An upright or sharply inclined lip 63 is optionally provided at or proximal the end of the limit member 62 to provide tactile feedback to the user that the maximum extent has been approached or reached, and that further operation without a change in direction will result in access being prevented, and requiring the operating sequence to be restarted.

In this position, attempting to further open the drawer or door will cause the follower 28 to abut the front wall 80, which will block the drawer or door from opening further, and prevent access to or use of the area or equipment to which access is controlled. It will be recognized that the distance of travel of the drawer or door between the starting or neutral position shown in FIG. 3, and the blocked position shown in FIG. 8A may be selectively varied depending on the desired application, equipment to which the apparatus is applied, and the expected user(s), but will be less than a threshold opening space or distance that would allow the user to access the protected space or equipment. In this manner, a user who lacks knowledge or understanding of the operation of the apparatus and method of the present invention, and attempts to open the drawer or door in a single continuous opening motion, as would typically be employed to open such equipment, will be blocked from access or use.

As shown in FIG. 8B, after reaching the blocked position, returning the drawer or door toward the closed position (movement to the right in the figures) returns the follower 28 back through the first one-way gate 60, returning to the starting or neutral position. The user can then make another attempt to open or operate the associated equipment. In alternate embodiments, the follower may be captured in a blocked position, preventing further attempts to open or operate the associated equipment, by provision of one or more stop surfaces, either permanently disabling the associated equipment or temporarily preventing further operation until an authorized user unlocks the assembly.

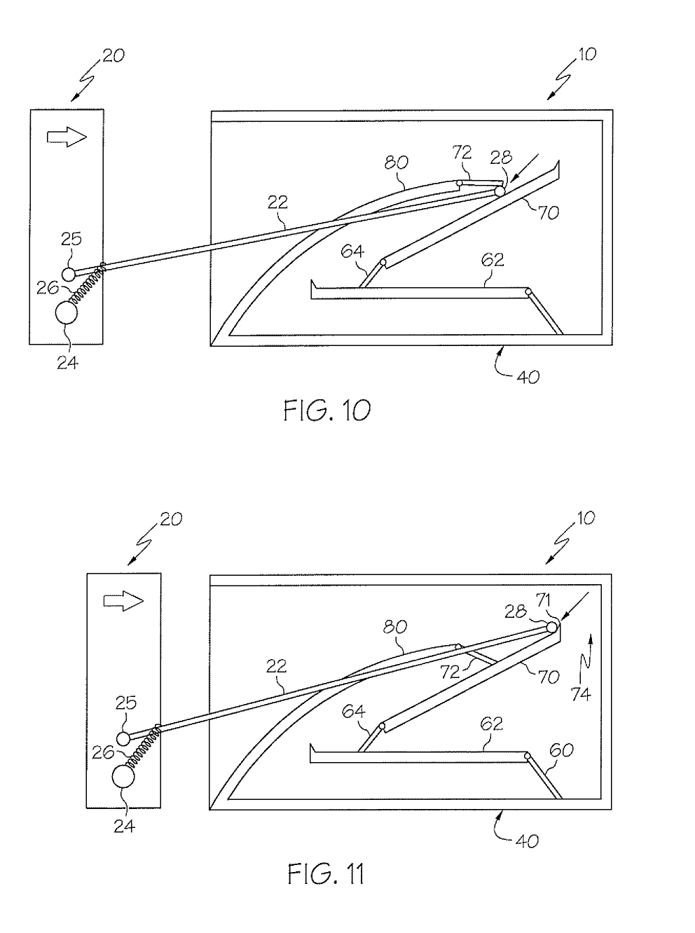

With reference now to FIG. 9, if instead of attempting to further open the drawer, door or other associated equipment upon sensing the click, vibration or other feedback indicated upon passage of the follower 28 through the second one-way gate 64, the user changes the direction of actuation to move back toward the closed position (to the right, as shown in FIG. 9) the follower passes over and along the second one way gate, and along a second interior limit member 70. The follower 28 continues along the second interior limit member 70 as the drawer or door is further closed, until it passes through a third one-way gate 72, as shown in FIG. 10. Upon passing through the third one-way gate 72, another audible, tactile or other feedback indication is generated; indicating to the user that another change in direction is required to stay on the “allow-access” portion of the actuation pathway.

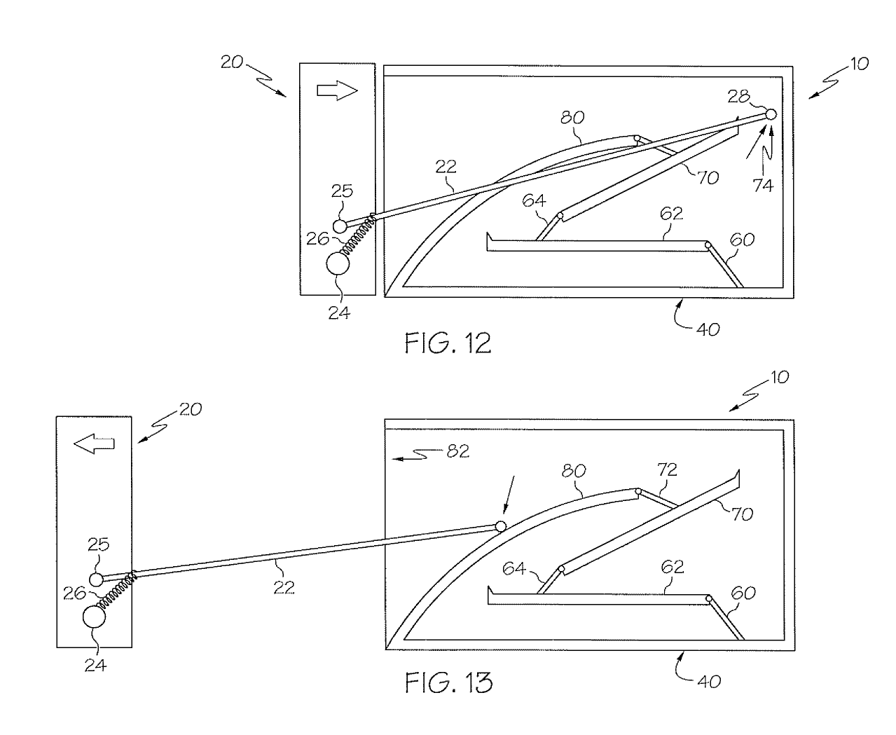

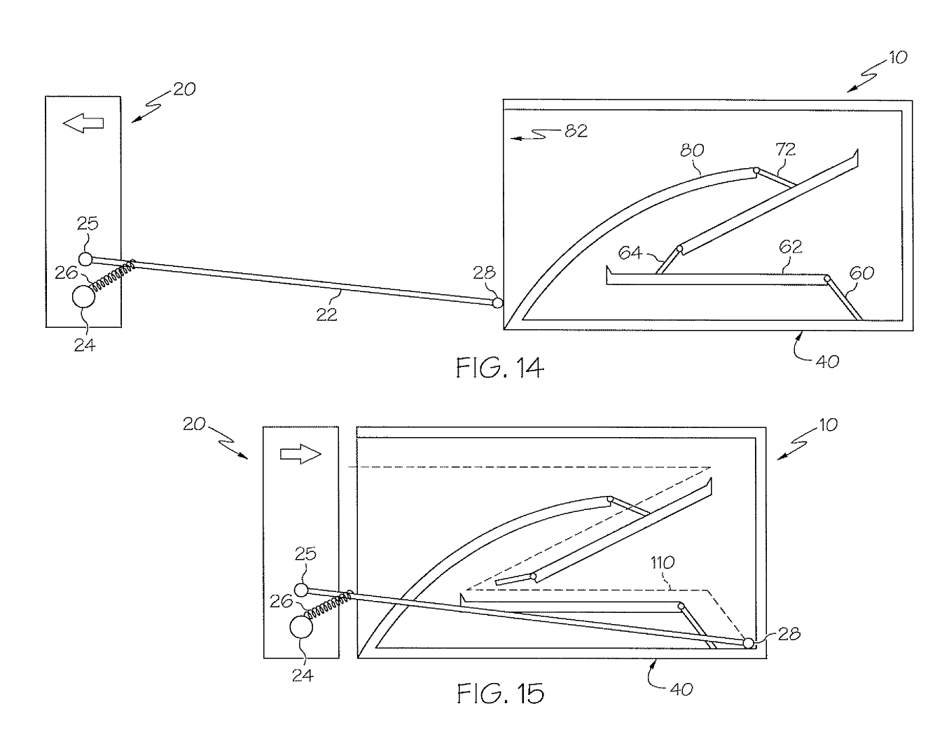

If the user continues pushing the drawer or door toward its closed position, as shown in FIGS. 11 and 12, the follower 28 passes over the end of the second interior limit member 70, and returns to the starting position under the bias of the spring 26. Optionally, an upright or sharply inclined lip 71 is provided at or proximal the end of the limit member 70 to provide tactile feedback to the user that the maximum extent has been approached or reached, and that further operation without a change in direction will result in access being prevented, and requiring the operating sequence to be restarted. If instead, the user again changes the direction of actuation to move the drawer or door back toward the open position (to the left as shown in FIG. 13) upon sensing the feedback indication, the follower 28 passes along and over the closed third one-way gate 72. As the drawer or door is opened further, the follower 28 passes along a third interior limit member 80, and out through a release passage 82, as shown in FIG. 14, to release the drawer, door or other associated equipment for access and/or operation. Optionally, one or more return pathways are provided for returning the follower 28 to the starting position when the drawer or door is again closed. For example, in the depicted embodiment, the proximal end of the second part 40 (the end facing the first part 20) is open, and an inclined or convexly curved front wall 80 extends distally inward from the bottom wall 42, allowing the follower 28 to re-enter the second part and reset the mechanism when the first part is closed. In alternate embodiments, a one-way reentry door or gate at the proximal end of the second part 40 allows the follower to reenter the mechanism upon closing.

The one-way gates described herein are preferably movable between an open position that allows passage of the follower 28 between one limit member and an adjacent limit member in a first direction of actuation, and a closed position that bridges a space between adjacent limit members and allows the follower to follow along an inclined face of the gate as it moves in an opposite second direction of actuation along a pathway between the adjacent limit members. The one-way gates may be spring-biased, weighted for gravity bias in a downward direction, magnetically biased, formed of a resilient material, or otherwise biased toward the closed position.

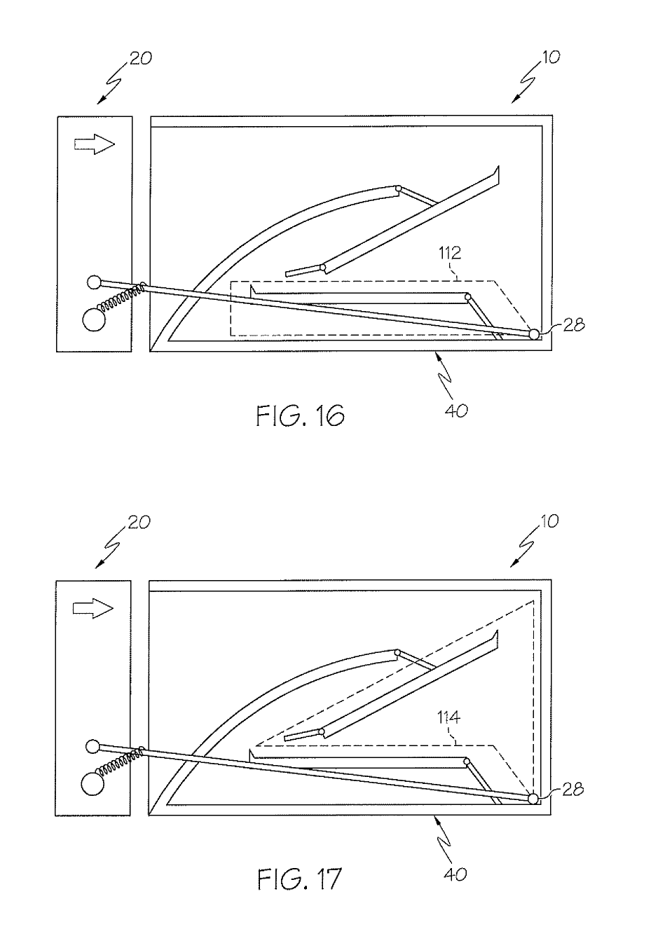

Example embodiments of the access control apparatus enable methods of access control, which methods are also within the scope of the present invention. For example, and with reference to example embodiments depicted in FIGS. 15-17, methods of access control according to the present invention comprise actuating a first part 20 relative to a second part 40 to move one of the parts along a serpentine or multi-directional follower path. The follower path preferably comprises at least one “allow-access” pathway portion, as indicated by the path 110 shown in broken lines in FIG. 15; and at least one “prevent-access” pathway portion, as indicated by paths 112 and 114 in FIGS. 16 and 17 respectively. In example embodiments, the “allow-access” pathway comprises at least two pathway segments in a first direction of actuation, and at least one pathway segment in a generally opposite second direction of actuation between the at least two pathway segments in the first direction, for example in the form of the generally Z-shaped “allow-access” pathway 110 shown in FIG. 15. One or more additional pathway segments can optionally be included, resulting in multiple Z-shaped or otherwise configured access pathways.

The access control apparatus or mechanism is biased to default to a “prevent-access” pathway portion if a user attempts to operate the associated equipment according to a standard or intuitive mode of operation. For example, if a user attempts to open a drawer or door simply by pulling it toward its open position in normal fashion, the access control apparatus operates to prevent access to a space within the drawer or door. On the other hand, if a user knows the “allow-access” pathway and follows a corresponding actuation sequence, which is preferably a non-standard or non-intuitive mode of operation of the associated equipment, the access control apparatus releases the associated equipment for access and use. Even if an unauthorized user is lucky and accidentally stops pulling the drawer and starts pushing it after passing the second gate, they would have to get lucky and change direction a second time after passing the third gate, or the mechanism would reset to the locked or “prevent-access” position. As such, the likelihood of accidental unauthorized access is very small. Additional direction changes can be added to the apparatus and method of the invention to further reduce the likelihood of accidental unauthorized access or use of the associated equipment. Additionally, one or more “dummy” gates or feedback indicators can be included to further limit unauthorized users from accidental access or use.

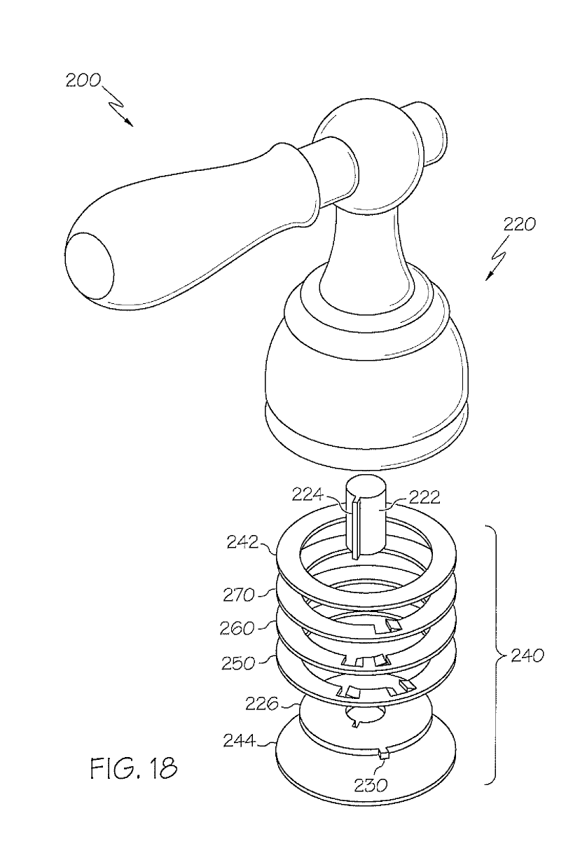

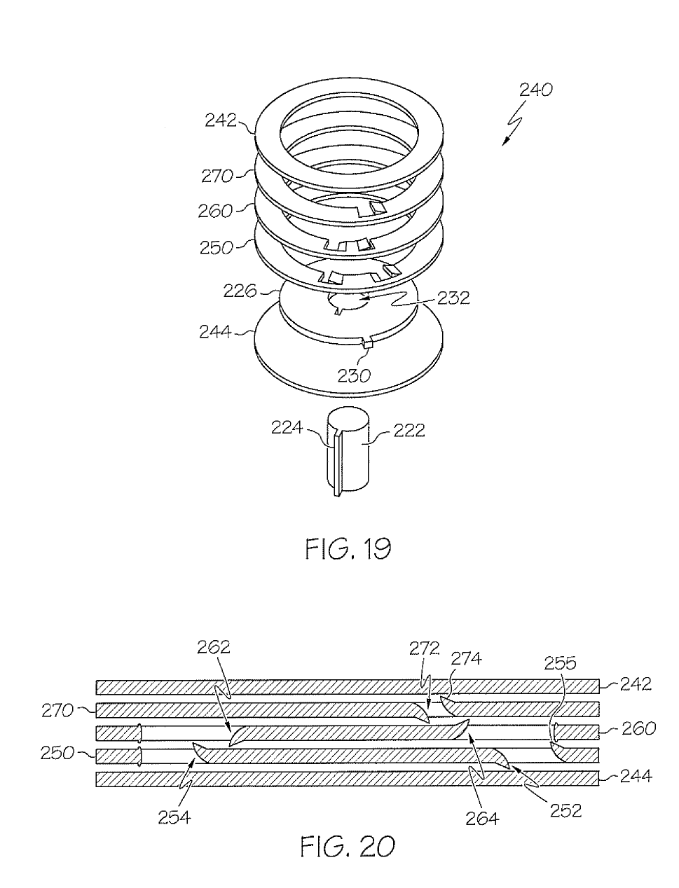

FIGS. 18-22 show an access control apparatus 200 according to another example embodiment of the present invention, which controls access to or use of rotationally actuated associated equipment. In the depicted embodiment, the access control apparatus 200 generally comprises a first part 220 and a second part 240. In example embodiments, the first part 220 is rotationally movable relative to the second part 240, for example, wherein the first part 220 is in the form of a handle or knob (e.g., pivotal or rotatable) and the second part 240 comprises a plurality of assembled ring-like components for engagement therewith.

The first part 220 generally comprises a base portion and an arm or handle portion, and the arm portion generally extends transversely relative to the base portion. In alternate embodiments, the first part 220 can be shaped as desired. In example embodiments, the base portion of the first part 220 comprises a key-way or configured opening (unshown) to receive an end of a key member 222. The key member 222 is generally cylindrical-shaped and comprises a rib-like projection 224 (i.e., key portion) that extends the axial length along the periphery thereof. In one form, the key member 222 engages with the similarly contoured key-way of the first part 220 and extends to engage a substantially similar contoured key-way 232 of a follower ring member 226. As such, the key member 222 couples between the first part 220 and the follower ring member 226 by extending through a portion of the second part 240.

The second part 240 is generally formed from an assembly of ring-like members having a substantially similar outer and inner contour. In example embodiments, a central opening extending therethrough defines the substantially similar inner contour of the ring-like members. In the depicted embodiment, top and bottom disk members 242, 244 are generally uniform and preferably illustrate and represent one form of a casing that can be used to enclose a plurality of centrally-positioned ring-like members or rings therebetween. Alternatively, in other embodiments, the outer members 242, 244 can be neglected when other means of enclosure is provided.

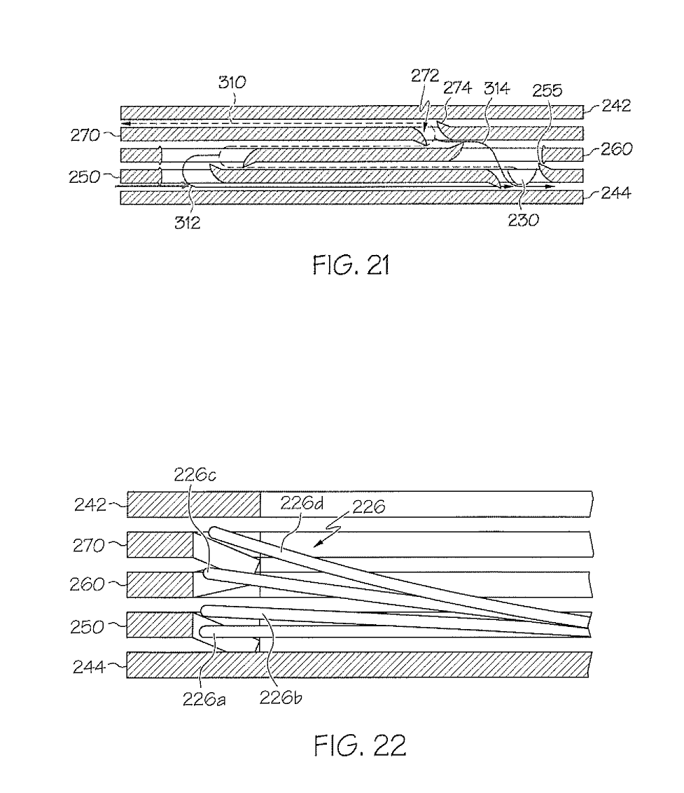

The centrally-positioned rings generally form a first ring 250, a second ring 260, and a third ring 270. In alternate embodiments, the centrally-positioned rings can comprise a desired quantity (e.g., one ring, five rings, etc.). Preferably, each ring comprises at least one cut-out portion to provide engagement with a flange or follower 230 extending from the follower ring member 226. Also preferably, the follower ring member 226 is generally sized, shaped and formed to accommodate engagement therewith, for example, the outer contour of the follower member 226 is substantially similar to the inner contour of the first, second and third rings 250-270, and wherein the flange or follower 230 extending therefrom provides engagement with the plurality of cut-out portions. In example embodiments, the cut-out portions form limiting portions and/or one-way portions that define one or more serpentine follower path(s), as similarly described above. For example, the follower paths preferably comprise at least one “allow-access” pathway portion, and at least one “prevent-access” pathway portion, with a bias or default towards the “prevent-access” pathway portion if a user does not follow a prescribed actuation sequence (e.g., clockwise-counterclockwise motion) (see FIG. 21). While the apparatus and method are described with reference to the example embodiments depicted having a specified clockwise-counterclockwise actuation sequence, it will be understood that alternate embodiments may utilize a counterclockwise-clockwise sequence within the scope of the invention.

FIG. 20 shows a side view of the second part 240. In the depicted embodiment, the cut-out portions define the limits that the flange 230 must remain between to remain on the “allow-access” pathway. For example, the first ring 250 comprises a first cut-out portion defining a one-way access end 252 and a second cut-out portion defining a limiting end 254. The second ring comprises a first cut-out portion defining a one-way access end 262 and a second cut-out portion defining a limiting end 264. Further, the third ring 270 comprises a first cut-out portion defining a first one-way access end 272, and a second cutout portion defining a second one way access end 274. Preferably, as will be discussed below, the flange 230 of the follower ring member 226 is preferably shaped and sized to accommodate desirable engagement with the limiting ends and one-way access ends of the cut-out portions.

As best seen in FIG. 21, the follower path preferably comprises at least one “allow-access” pathway portion, as indicated by the path 310 shown in broken lines; and at least one “prevent-access” pathway portion, as indicated by paths 312 and 314. In example embodiments, the “allow-access” pathway comprises at least two pathway segments in a first rotational direction (e.g., clockwise), and at least one pathway segment in a generally opposite second rotational direction (e.g., counter-clockwise).

In example forms of operation, the first part 220 is rotated in a clockwise direction, and causes the follower ring member 226 coupled thereto to rotate the same. Preferably, as the flange 230 of the follower ring 226 provides engagement with the cut-out portions, the follower ring member 226 is formed from a resilient material to provide for flexing when moving along the pathways (see FIG. 22). In example embodiments, the starting position of flange 230 is generally within the first cut-out portion of the first ring 250 (see 226a of FIG. 22). As such, the flange 230 extending from the outer periphery of the follower ring member 226 (moving from right to left in the figure) engages the one-way access end 252 and is biased to move along the top of the first ring 250 (see 226b of FIG. 22). As the first part 220 continues to rotate clockwise, the flange 230 moves under the one-way access end 262 of the second ring 260. In this position, the flange 230 is generally within a portion of the first cut-out portion of the second ring 260, and can either move further along the “allow-access” pathway 310 by changing the direction of operation (from right-to-left to left-to-right), or continue with movement in the clockwise direction wherein the flange moves over the limiting end 254 of the first ring 250 to move along the “prevent access” pathway 312.

To continue along the “allow-access” pathway 310, the first part 220 is then rotated in a counter-clockwise direction (moving from left to right in the figure). As such, the flange 230 engages the one-way access end 262 and is biased to move along the top of the second ring 260 (see 226c of FIG. 22). As the first part 220 continues to rotate counter-clockwise, the flange 230 moves under the one-way access end 272 of the third ring 270. In this position, the flange 230 is generally within a portion of the first cut-out portion of the third ring 270, and can either move further along the “allow-access” pathway 310 by again changing the direction of operation (from left-to-right to right-to-left), or continue with movement in the counter-clockwise direction wherein the flange moves over the limiting end 264 of the second ring 260 to move along the “prevent access” pathway 314. To continue further along the “allow-access” pathway 310, the first part 220 is then rotated in a clockwise direction (moving from right to left in the figure) and the flange 230 engages the first one-way access end 272 and is biased to move along the top of the third ring 270 (see 226d of FIG. 22). Once the flange 230 is positioned along the top of the third ring 270, the first part 220 can freely rotate further in the clockwise direction (i.e., providing sufficient rotation to actuate for its intended use) to allow the user to rotate the handle 200 as many turns as required in the clockwise direction, with the follower 230 riding over the one way access ends 274 and 272 of the third ring 270 (from right to left in FIGS. 20 and 21). When closing the associated equipment by turning the handle 200 counterclockwise, the follower flange 230 moves left to right, and will be caught by the second one way access end 274 of the third ring 270, and follow the return path 314, drop below end 255 of ring 250, and be free to rotate back as many turns as desired. Optionally, the access control apparatus 200 can be configured to provide sufficient rotation of the first part 220 in a counter-clockwise direction (i.e., when the flange 230 is moving along the top of the third ring 270).

The access control mechanism of the present invention may be incorporated into a kit for retrofitting to existing associated equipment, or alternatively can be incorporated into original equipment components such as cabinet hinges, drawer rails, faucets, or other associated equipment so that users would not need to install retrofit equipment afterward. A childproof hinge, drawer, faucet or other associated equipment to which access is to be controlled can be selected at the time of purchase or built into the original construction of a house, and activated with a button, screw or other activation mechanism when childproof operation is needed, and deactivated when not needed.

While the invention has been described with reference to preferred and example embodiments, it will be understood by those skilled in the art that a variety of modifications, additions and deletions are within the scope of the invention, as defined by the following claims.

What is claimed is:

1. An access control apparatus for controlling access to associated equipment, the access control apparatus comprising:
a follower path comprising at least one allow-access pathway portion, and at least one prevent-access pathway portion;
a follower movable along the follower path; and
biasing means for biasing the follower toward the prevent-access pathway portion upon a standard actuation of the associated equipment, and for allowing the follower to follow the allow-access pathway portion upon a non-standard actuation of the associated equipment;
wherein the prevent-access pathway portion limits operation of the associated equipment and wherein the allow-access pathway portion allows operation of the associated equipment.

2. The access control apparatus of claim 1, further comprising at least one limit member defining the follower path.

3. The access control apparatus of claim 2, further comprising a one-way gate coupled to one of the at least one limit members.

4. The access control apparatus of claim 3, comprising a plurality of limit members defining the follower path, wherein the one-way gate is movable between a closed position that bridges a first limit member and a second limit member, and an open position that allows passage of the follower between the first limit member and the second limit member.

5. The access control apparatus of claim 4, wherein the one one-way gate is pivotally coupled to the second limit member.

6. The access control apparatus of claim 1, wherein the follower projects from a follower arm that is biased toward a starting position.

7. The access control apparatus of claim 1, wherein the associated equipment is linearly actuated.

8. The access control apparatus of claim 1, wherein the associated equipment is rotationally actuated.

9. The access control apparatus of claim 1, wherein the allow-access pathway portion comprises at least one pathway segment in a first direction of actuation, and at least one pathway segment in a generally opposite second direction of actuation.

10. The access control apparatus of claim 1, wherein the allow-access pathway portion comprises at least two pathway segments in a first direction of actuation, and at least one pathway segment in a generally opposite second direction of actuation between the at least two pathway segments in the first direction.

11. The access control apparatus of claim 10, wherein the allow-access pathway portion defines at least one generally Z-shaped path.

12. The access control apparatus of claim 1, wherein the follower is translationally actuated to move along the follower path.

13. The access control apparatus of claim 1, wherein the follower is rotationally actuated to move along the follower path.

14. A method of controlling access to associated equipment, the method comprising:
providing an access control apparatus comprising a follower path having at least one allow-access pathway portion and at least one prevent-access pathway portion, and a follower movable along the follower path;
biasing the follower toward the prevent-access pathway portion upon a standard actuation of the associated equipment; and
selectively actuating the associated equipment to cause the follower to follow one of the allow-access pathway portion and the prevent-access pathway portion, whereby following the prevent-access pathway portion limits operation of the associated equipment and whereby following the allow-access pathway portion allows operation of the associated equipment.

15. The method of claim 14, wherein the associated equipment is actuated linearly.

16. The method of claim 14, wherein the associated equipment is actuated rotationally.

17. An access control apparatus comprising:
a first part having a follower arm extending therefrom, the follower arm being biased toward a starting position, and further comprising a follower extending from the follower arm; and
a second part comprising a first limit member, a second limit member, and a gate, the gate being movable between a closed position bridging the first and second limit members, and an open position allowing passage of the follower between the first and second limit members, the gate being biased toward the closed position, wherein the first and second limit members and the gate define an allow-access pathway and a prevent-access pathway, and wherein movement of the follower along the allow-access pathway allows opening of the access control apparatus and movement of the follower along the prevent-access pathway prevents opening of the access control apparatus.

18. The access control apparatus of claim 17, wherein the first part comprises a fixed part and the second part comprises a movable part.

19. The access control apparatus of claim 17, wherein the first part is coupled to a linearly actuated associated equipment component.

20. The access control apparatus of claim 17, wherein the first part is coupled to a rotationally actuated associated equipment component.
